(19) United States
(12) Patent Application Publication
(10) Pub. No.: US 2025/0009600 A1
(43) Pub. Date: Jan. 9, 2025

(54) PALM TYPE MASSAGE APPARATUS

(71) Applicant: Tzong-Yann LEE, Taipei City (TW)

(72) Inventors: Tzong-Yann LEE, Taipei City (TW); Hsin-Hui WANG, Taipei City (TW)

(21) Appl. No.: 18/600,648

(22) Filed: Mar. 9, 2024

(30) Foreign Application Priority Data
Jul. 3, 2023 (TW) 112206852
Oct. 12, 2023 (TW) 112210977

(51) Int. Cl. A61H 39/04; A61H 7/00

(52) U.S. Cl. CPC A61H 39/04; A61H 7/003; A61H 2201/0153; A61H 2201/1253; A61H 2201/1695

(57) ABSTRACT

A palm type massage apparatus includes a press part and a grip part. The press part has an abutting curved surface, and the grip part is connected to a side of press part opposite to the abutting curved surface and has a grip length equal to or smaller than 10 cm, so that the palm type massage apparatus is convenient to carry and hold, and allows users to massage their acupoints and fascia anytime and anywhere.

### BACKGROUND OF THE DISCLOSURE

### Technical Field

The present disclosure relates to a massage apparatus, and more particularly relates to a palm type massage apparatus which is easy to carry and hold, and capable of targeting at the acupoints and fascia of the human body for massage and relaxation.

### Related Art

The fast pace of modern life and the lack of exercise due to busyness often lead to back pain, accumulated fatigue, or tension and discomfort of the body's muscles and fascia after intensive exercise. Therefore, there are many massage apparatuses, such as massage rollers, massage balls, electric massage rods and electric massage chairs on the market.

However, the massage rollers and massage balls are generally large in size and unable to be carried around easily due to their size, and electric massage rods and electric massage chairs are not only large in size, but also need to rely on electricity to operate, which incurs a relatively high cost. Therefore, how to design a convenient-to-carry and effective massage apparatus for massaging acupoints and fascia to reduce the pressure and discomfort anytime and anywhere and improve the shortcomings of the related-art massage apparatus is in urgent need.

In view of this problem, the present discloser has focused on the above-mentioned drawbacks of the related art to conduct extensive research and experiment and overcome the above-mentioned problems.

### SUMMARY OF THE DISCLOSURE

The primary objective of the present disclosure is to provide a palm-type massage device that is easy to carry and hold, and to enable users to target at acupoints and fascia for massage and relaxation anytime and anywhere.

To achieve the aforementioned objective, the present disclosure provides a palm type massage apparatus including a press part and a grip part, the press part has an abutting curved surface, the grip part is connected to a side of the press part opposite to the abutting curved surface, and the grip part has a grip length equal to or smaller than 10 cm.

In an embodiment of the present disclosure, the length of the grip falls within a range of 6˜8 cm.

In an embodiment of the present disclosure, the diameter of the abutting curved surface is greater than or equal to 2 mm and equal to or smaller than 10 mm

In an embodiment of the present disclosure, the diameter of the abutting curved surface is greater than or equal to 4 mm and equal to or smaller than 8 mm.

In an embodiment of the present disclosure, the press part is in a hemispherical shape.

In an embodiment of the present disclosure, the press part is in a plate-shape, and has a pair of connecting bevels, the connecting bevels extend outwardly and obliquely from two ends of the abutting curved surface and connected to the grip part.

In an embodiment of the present disclosure, the thickness of the press part is greater than or equal to 1 mm and equal to or smaller than 7 mm.

In an embodiment of the present disclosure, the thickness of the press part is greater than or equal to 3 mm and equal to or smaller than 5 mm.

In an embodiment of the present disclosure, the grip part has a first plane, a second plane and a grip curved surface, and the first plane and the second plane are connected to two sides of the grip curved surface respectively.

In an embodiment of the present disclosure, the diameter of the grip curved surface falls within a range of 4˜10 cm.

In an embodiment of the present disclosure, the diameter of the grip curved surface is greater than or equal to 6 cm and equal to or smaller than 8 cm.

In an embodiment of the present disclosure, an included angle is defined between the first plane and the included angle is greater than or equal to 5° and equal to or smaller than 85°.

In an embodiment of the present disclosure, the included angle falls is greater than or equal to 10° and equal to or smaller than 45°.

In an embodiment of the present disclosure, the grip part includes a conical section and a hemispherical section, the conical section gradually expands and extends from the press part toward the hemispherical section, and the hemispherical section has a grip curved surface.

In an embodiment of the present disclosure, the diameter of the grip curved surface is greater than or equal to 4 cm and equal to or smaller than 10 cm.

In an embodiment of the present disclosure, the diameter of the grip curved surface is greater than or equal to 6 cm and equal to or smaller than 8 cm.

In an embodiment of the present disclosure, the palm type massage apparatus further includes a universal joint disposed pivotally on a side of the grip part away from the press part.

In an embodiment of the present disclosure, the universal joint has a suction cup.

In an embodiment of the present disclosure, the grip part has a fixed hole.

In an embodiment of the present disclosure, the grip part has a pivot hole.

In an embodiment of the present disclosure, the press part has an abutting end and a connecting end opposite to each other, the connecting end has a first combining portion, and the grip part has a second combining portion detachably combined and fixed to the corresponding first combining portion.

In an embodiment of the present disclosure, the first combining portion is one of a screw hole and a stud, the second combining portion is the other one of the screw hole and the stud, and the stud is screwed and locked into the screw hole.

In an embodiment of the present disclosure, the first combining portion is one of a recessed hole and a protruding column, the second combining portion is the other one of the recessed hole and the protruding column, and the protruding column is accommodated and engaged in the recessed hole.

In an embodiment of the present disclosure, the protruding column has a block extending from a sidewall of the protruding column, a notch formed on a side of the recessed hole, and the block passes through the corresponding notch.

In an embodiment of the present disclosure, the press part expands gradually from the abutting end toward the connecting end.

In an embodiment of the present disclosure, the abutting end is in a semi-circular disc shape, the abutting end has a pair of side planes, and the abutting curved surface is connected between the side planes.

In an embodiment of the present disclosure, the grip part is in a hemispherical shape, the grip part has an end surface and a grip curved surface, and the second combining portion is disposed on the end surface.

In an embodiment of the present disclosure, the palm type massage apparatus further includes an extension part detachably installed between the press part and the grip part.

In an embodiment of the present disclosure, the extension part has a third combining portion and a fourth combining portion disposed on two sides of the extension part respectively, the structure of the third combining portion is the same as the structure of the second combining portion and is detachably combined and fixed to the corresponding first combining portion, and the structure of the fourth combining portion is the same as the structure of the first combining portion and is detachably combined and fixed to the corresponding second combining portion.

In an embodiment of the present disclosure, the extension part is in a disc shape or a cylindrical shape.

In the palm type massage apparatus of the present disclosure, the grip part has a grip length equal to or smaller than 10 cm, and the press part has an abutting curved surface, so that the palm-type massage device is easy to carry and hold, and allows users to target their own acupoints and fascia for massage and relaxation anytime and anywhere.

### BRIEF DESCRIPTION OF THE DRAWINGS

FIG. 1 is a perspective view of a first embodiment of the present disclosure;

FIG. 2 is a top view of the first embodiment of the present disclosure;

FIG. 3 is a side view of a first embodiment of the present disclosure;

FIG. 4 is a schematic view showing a using status of the first embodiment of the present disclosure;

FIG. 5 is a perspective view of a second embodiment of the present disclosure;

FIG. 6 is a top view of the second embodiment of the present disclosure;

FIG. 7 is a side view of the second embodiment of the present disclosure;

FIG. 8 is a perspective view of a third embodiment of the present disclosure;

FIG. 9 is a side view of the third embodiment of the present disclosure;

FIG. 10 is another side view of the third embodiment of the present disclosure;

FIG. 11 is a schematic view showing a using status of the third embodiment of the present disclosure;

FIG. 12 is a schematic view showing another using status of the third embodiment of the present disclosure;

FIG. 13 is a perspective view of a fourth embodiment of the present disclosure;

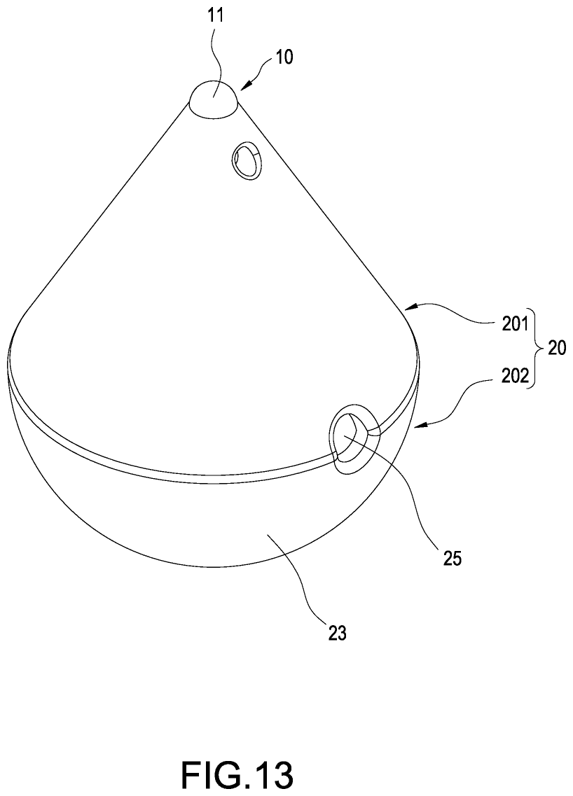

FIG. 14 is a side view of the fourth embodiment of the present disclosure;

FIG. 15 is a perspective view of a fifth embodiment of the present disclosure;

FIG. 16 is an exploded view of the fifth embodiment of the present disclosure;

FIG. 17 is an exploded view of a sixth embodiment of the present disclosure;

FIG. 18 is a perspective view of the sixth embodiment of the present disclosure; and

FIG. 19 is an exploded view of a seventh embodiment of the present disclosure.

### DETAILED DESCRIPTION

The technical characteristics of this disclosure will become apparent with the detailed description of preferred embodiments accompanied with the illustration of related drawings as follows. It is noteworthy that the embodiments and drawings disclosed herein are to be considered illustrative rather than restrictive.

In the description of this disclosure, it should be understood that the terms “front side”, “rear side”, “left side”, “right side”, “front”, “rear”, “end”, “longitudinal”, “lateral”, “vertical”, “top”, “bottom”, etc. are based on the orientation or positional relationships shown in the accompanying drawings, which are intended only to facilitate description of the present disclosure and to simplify the description, and are not intended to be indicative or implied. The device or component referred to must have a specific orientation, be constructed and operated in a specific orientation, and therefore should not be construed as a limitation on the present disclosure.

As used herein, terms such as “first”, “second”, “third”, “fourth” and “fifth” describe various elements, components, regions, layers and/or portions that should not be limited by these terms. These terms may only be used to distinguish one element, component, region, layer or part from another. The use of these terms does not imply order or subordination unless the context clearly indicates otherwise.

The technical characteristics of the present disclosure will become apparent in the following detailed description of the preferred embodiments with reference to the accompanying drawings. It is intended that the embodiments and drawings disclosed herein are to be considered illustrative rather than restrictive.

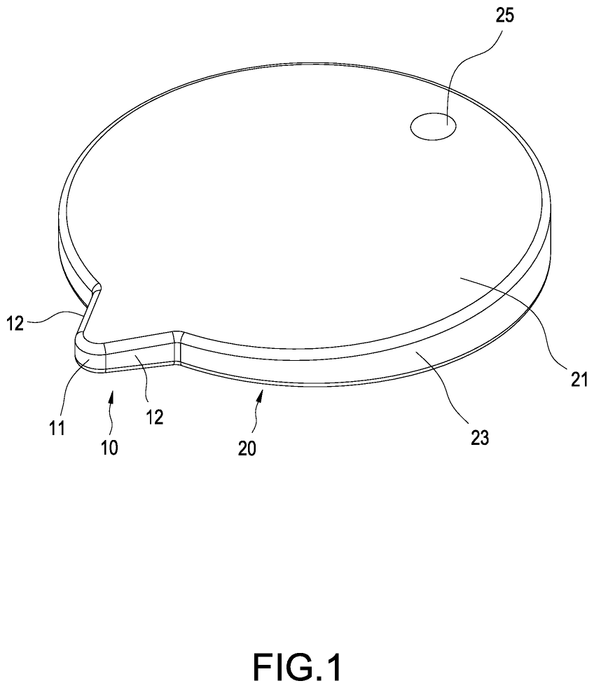

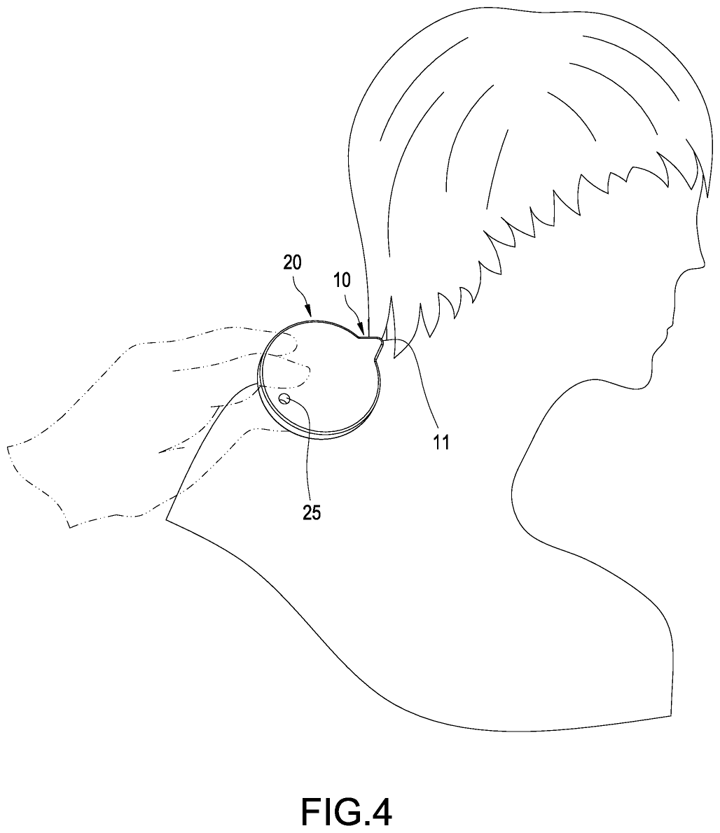

The present disclosure provides a palm type massage apparatus, which is provided for users to grasp in the palm, in order to massage their acupoints and fascia and relax their the body. With reference to FIGS. 1 to 4 for the first embodiment of the present disclosure, the palm type massage apparatus mainly includes a press part 10 and a grip part 20.

In this embodiment, the press part 10 is a triangular plate, but the present disclosure is not limited thereto. The press part 10 has an abutting curved surface 11. In a specific embodiment, the abutting curved surface 11 is formed at a corner of the front end of the press part 10. The abutting curved surface 11 has a diameter greater than or equal to 2 mm and equal to or smaller than 10 mm. In some embodiments, the abutting curved surface 11 has a diameter greater than or equal to 4 mm and equal to or smaller than 8 mm, so that when the press part 10 presses against the skin of the human body, it provides a deep massage effect without overstimulating the skin or acupoints.

In this embodiment, the grip part 20 is a disc shaped plate, but the present disclosure is not limited thereto. In a specific embodiment, the grip part 20 has a first plane 21, a second plane 22 and a grip curved surface 23, the first plane 21 and the second plane 22 are connected to two sides of the grip curved surface 23 respectively. The grip part 20 is connected to a side of the press part 10 opposite to the abutting curved surface 11, that is, connected to two corners of the rear end of the press part 10. The grip part 20 has a grip length 24 equal to or smaller than 10 cm. In a specific embodiment, the grip length 24 refers to the length from the junction of the grip part 20 and the press part 10 to the end of the grip part 20. In some embodiments, the grip length 24 greater than or equal to 6 cm and equal to or smaller than 8 cm to facilitate most users to grip and control the massaging apparatus easily.

In this way, the grip length 24 is controlled to be equal to or smaller than 10 cm to allow users to easily grip, use, carry and store the massage apparatus. In addition, the diameter of the abutting curved surface 11 designed to be greater than or equal to 4 mm and equal to or smaller than 8 mm provides a deep massage effect without overstimulating the skin or acupoints when the press part 10 presses against the human skin.

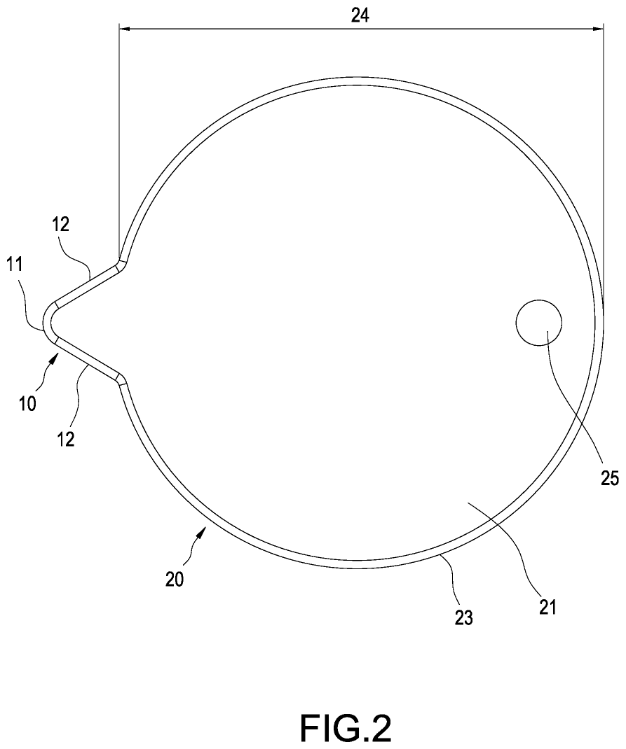

Further, the press part 10 of this embodiment has a pair of connecting bevels 12. The connecting bevels 12 are tilted and extended outwardly and obliquely from two ends of the abutting curved surface 11 and connected to the grip part 20. In the top view as shown in FIG. 2, the press part 10 of this embodiment is in a triangular shape, and the grip part 20 is in a circular shape. In addition, the press part 10 of this embodiment has a thickness greater than or equal to 1 mm and equal to or smaller than 7 mm. In some embodiments, the thickness of the press part 10 is greater than or equal to 3 mm and equal to or smaller than 5 mm, so that the press part 10 may not fail to provide the deep massage effect due to a too-large thickness, and may not overstimulate the skin or acupoints due to a too-small thickness.

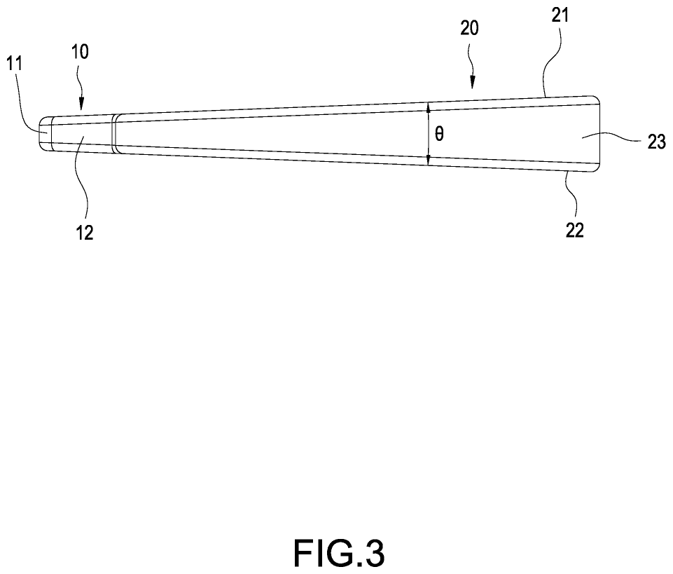

In FIGS. 2 and 3, the grip curved surface 23 has a diameter greater than or equal to 4 cm and equal to or smaller than 10 cm. In some embodiments, the diameter of the grip curved surface 23 greater than or equal to 5 cm and equal to or smaller than 8 cm, and the control of the grip length 24 of the grip part 20 enables most users to grip and hold the massaging apparatus easily. An included angle θ is defined between the first plane 21 and the second plane 22, and the included angle θ is greater than or equal to 5° and equal to or smaller than 85°. In some embodiments, the included angle θ is greater than or equal to 10° and equal to or smaller than 45° to facilitate users to grip and hold the first plane 21 and the second plane 22 of the grip part 20 by their thumb and other fingers in compliance with the principle of ergonomics.

The grip part 20 of this embodiment further includes at least one fixed hole 25 and at least one pivot hole (not shown in the figures). In this way, the user may insert a tool (such as a chopstick) into the fixed hole 25 as an extension of the acupoints that are not easily accessible (such as the back or the nape of the head), so that the user may hold the tool to adjust the position of the press part 10 to precisely move to the desired massage position and then lean back against the wall or the backrest of the chair to perform the massage. In addition, the palm type massage apparatus of this embodiment further includes a universal joint (not shown in the figures) pivoted into the pivot hole which is formed on a side of the grip part 20 away from the press part 10, and attached or fixed onto a piece of glass, a chair back or a wall by a suction cup or a bolt to facilitate users to lean against the massage apparatus for the massage.

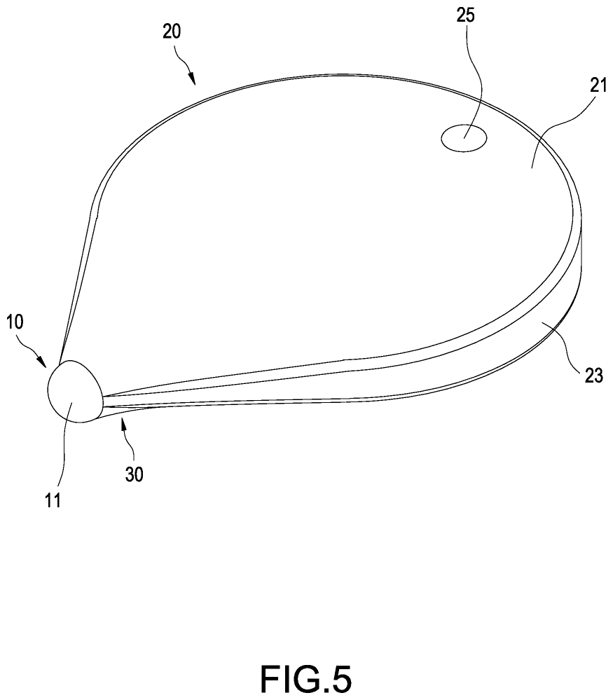

With reference for FIGS. 5 to 7 for the second embodiment of the present disclosure, the main difference between this embodiment and the first embodiment is that the press part 10 is in a hemispherical shape, so that the area of the abutting curved surface 11 is increased, which is more conducive for users to massage from different angles.

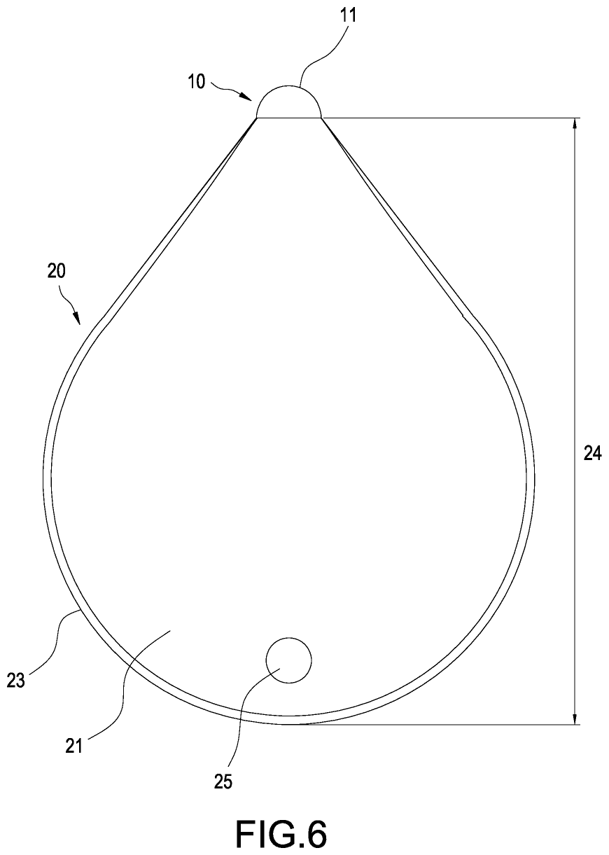

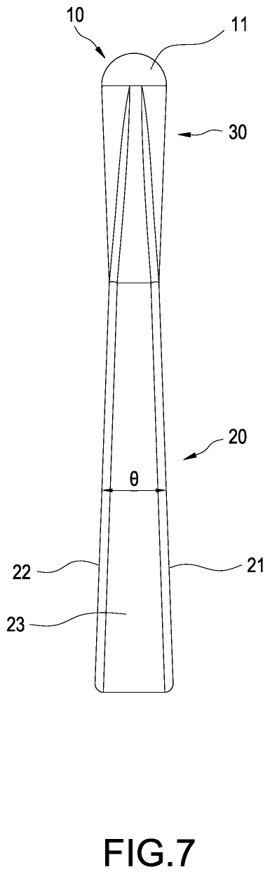

The grip part 20 of this embodiment is in a disc shape, but its front end is provided with a triangular plate extending from the connected position with the press part 10, so that in the top view as shown in FIG. 6, the press part 10 is in a semicircular shape, and the front end of the grip part 20 is in a triangular shape, and the rear end of the grip part is in a circular shape. In FIG. 7, the palm type massage apparatus of this embodiment further includes a connecting portion 30 extending from the press part 10 toward the middle of the grip part 20 to reinforce the structural strength of the connection between the two.

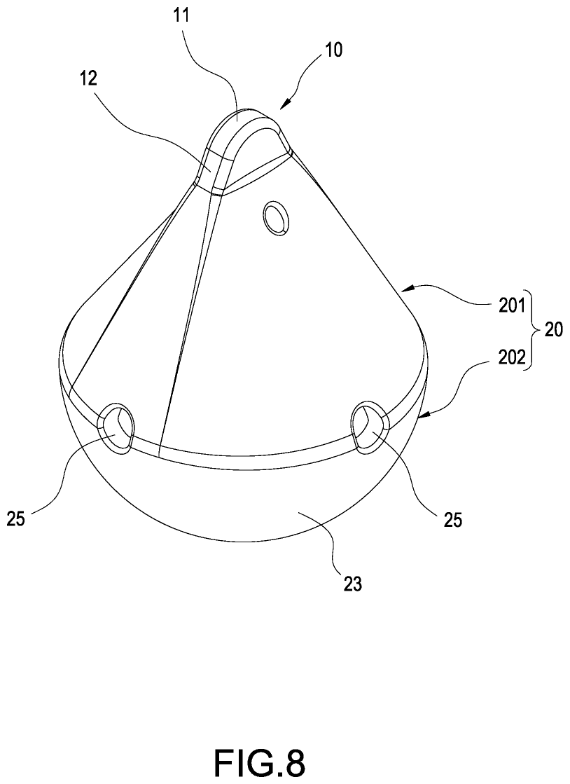

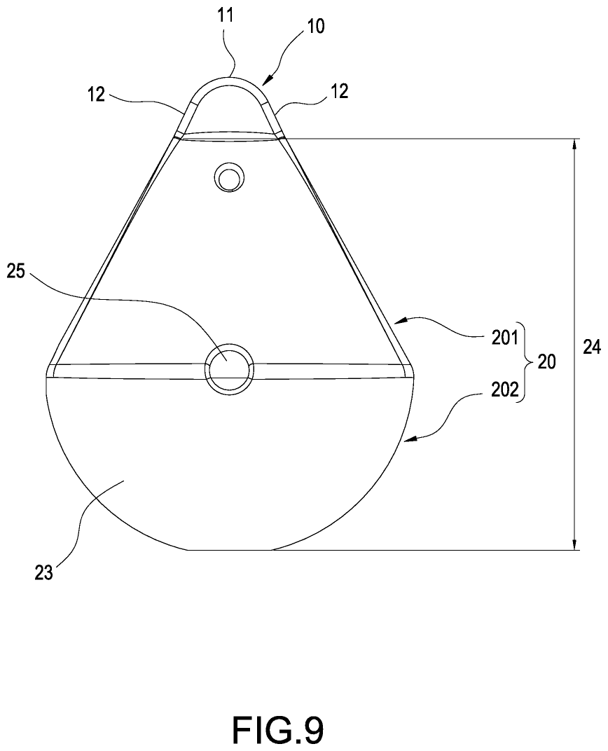

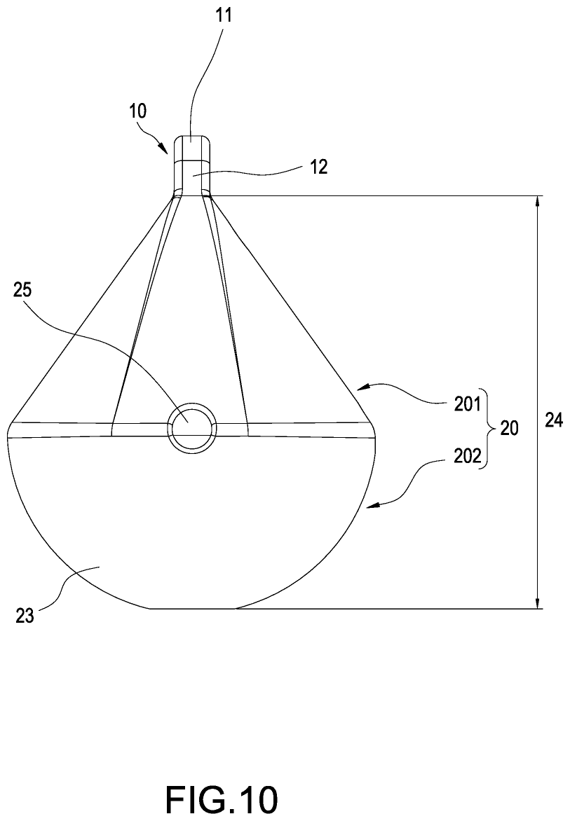

With reference to FIGS. 8 to 10 for the third embodiment of the present disclosure, the main difference between this embodiment and the first embodiment is the shape of the grip part 20. In this specific embodiment, the grip part 20 includes a conical section 201 and a hemispherical section 202. The conical section 201 expands gradually from the press part 10 toward the hemispherical section 202. The hemispherical section 202 has a grip curved surface 23. In the side view as shown in FIG. 9, the press part 10 of this embodiment is in a semicircular shape, the conical section 201 of the grip part 20 is in a trapezoidal shape, and the hemispherical section 202 at the rear end is in a semicircular shape. The diameter of the grip curved surface 23 is greater than or equal to 4 cm and equal to or smaller than 10 cm. In some embodiments, the diameter of the grip curved surface 23 is greater than or equal to 6 cm and equal to or smaller than 8 cm, and the control of the grip length 24 of the grip part 20 allows most users to grip, hold and control the massage apparatus easily.

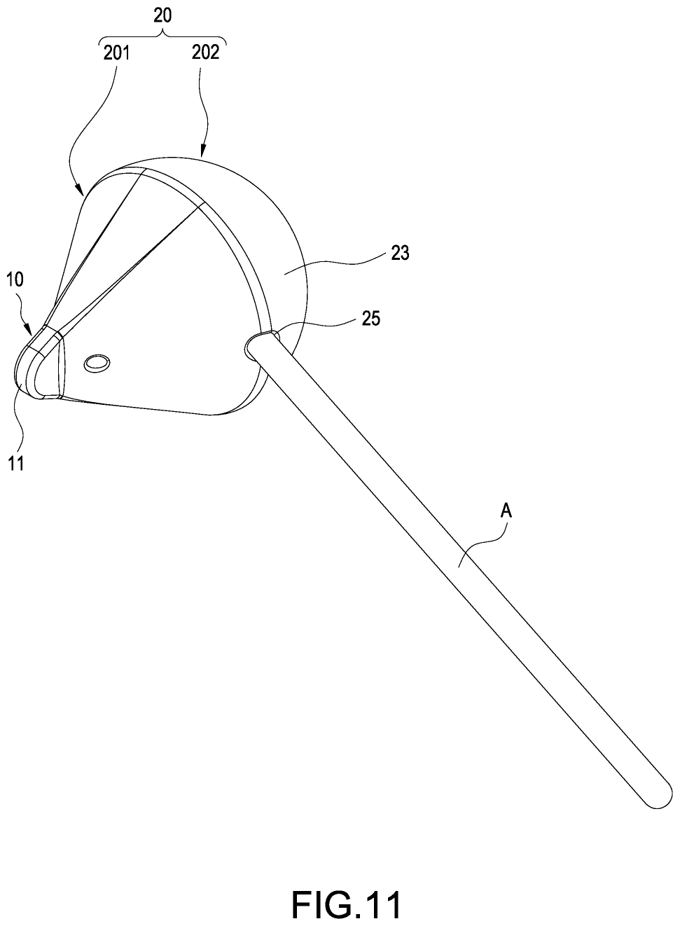

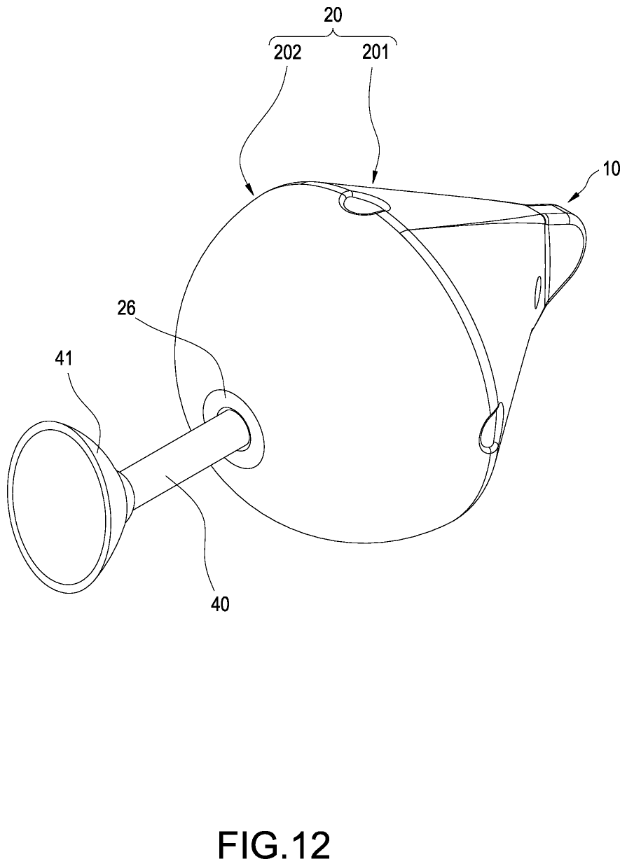

The grip part 20 of this embodiment further includes at least one fixed hole 25, at least one pivot hole 26 and a universal joint 40 which are the same as those of the first embodiment. In this specific embodiment as shown in FIG. 11, the fixed hole 25 is formed at the junction of the conical section 201 and the hemispherical section 202 and provided for users to insert a tool A (such as a chopstick) into the fixed hole 25 for an extension, to facilitate users to hold the tool A by hand in order to adjust positions and precisely move the press part 10 to the desired massaging positions and lean it against a wall or a chair back for massage. In FIG. 12, the pivot hole 26 is formed at the rear end of the hemispherical section 202. In this way, the universal joint 40 is pivoted into the pivot hole 26 of the hemispherical section 202, so that the suction cup 41 of the universal joint 40 is attached and fixed onto a piece of glass, a chair back or a wall to facilitate users to lean against it for massage.

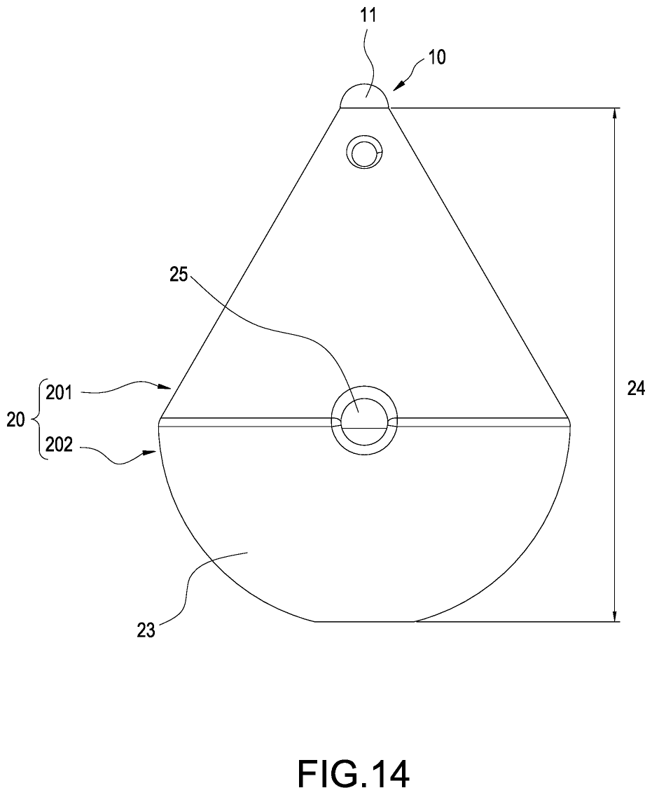

With reference to FIGS. 8 to 10 for the fourth embodiment of the present disclosure, the main difference between this embodiment and the third embodiment is that the press part 10 is in the hemispherical shape which is the same as the second embodiment, so that the area of the abutting curved surface 11 based on the third embodiment is increased, which is more conducive for users to massage at different angles. Therefore, in the side view of this embodiment as shown in FIG. 14, the press part 10 is in a semicircular shape, the conical section 201 of the grip part 20 is in a trapezoidal shape, and the hemispherical section 202 at the rear end is in a semicircular shape.

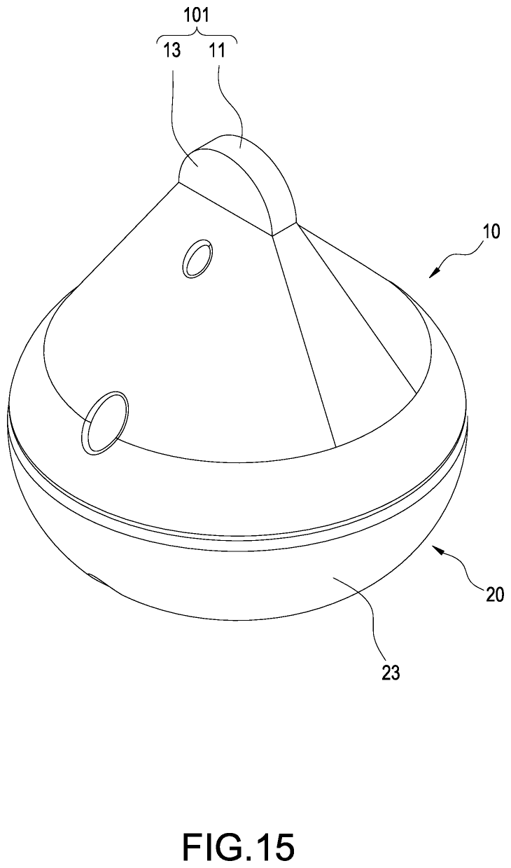

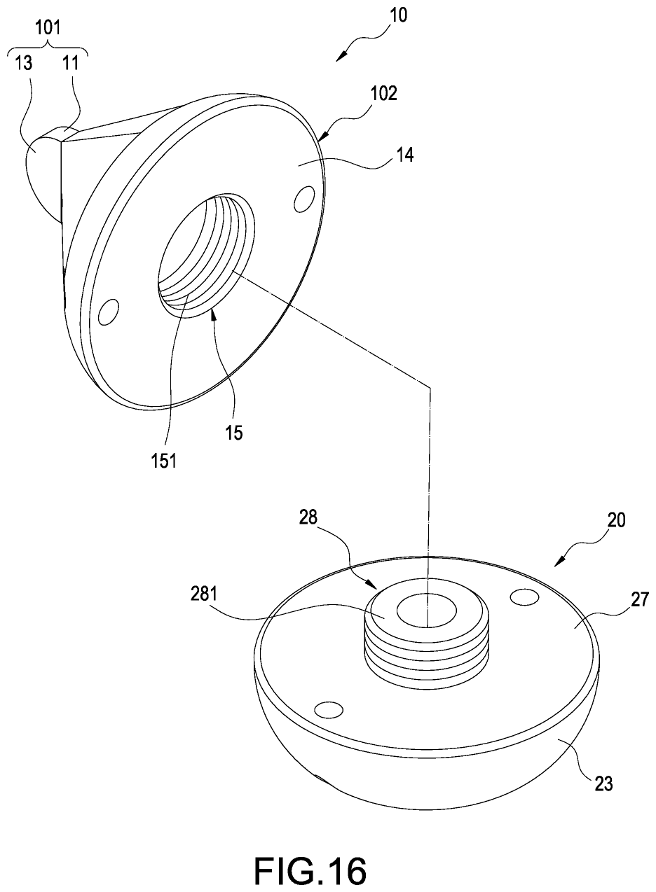

With reference to FIGS. 15 and 16 for the fifth embodiment of the present disclosure, the main difference between this embodiment and other previous embodiments is that the press part 10 of this embodiment is detachably installed onto the grip part 20.

In this specific embodiment, the press part 10 has an abutting end 101 and a connecting end 102 opposite to each other, the press part 10 expands gradually from the abutting end 101 toward the connecting end 102 to form a conical shape. In this embodiment, the abutting end 101 is in a semi-circular disc shape, but the present disclosure is not limited thereto. For example, it may be in a hemispherical shape or a plate shape. In this specific embodiment, the abutting end 101 has the aforementioned abutting curved surface 11 and pair of side planes 13, the abutting curved surface 11 is connected between the side planes 13 to form a semi-circular disc shape. The connecting end 102 has a connecting end plane 14 and a first combining portion 15. The first combining portion 15 is disposed on the connecting end plane 14.

In this embodiment, the grip part 20 is in a hemispherical shape, so as to facilitate users to grip and hold, but the present disclosure is not limited thereto. In this specific embodiment, the grip part 20 has an end surface 27 and the aforementioned grip curved surface 23 and second combining portion 28, and the grip curved surface 23 is connected to the end surface 27, so that the grip part 20 is in a hemispherical shape. The second combining portion 28 is disposed on the end surface 27. The second combining portion 28 is detachably combined and fixed to the corresponding first combining portion 15, so that the grip part 20 is detachable or installable to the press part 10.

In this way, the design the first combining portion 15 and the second combining portion 28 on the press part 10 and the grip part 20, and the second combining portion 28 detachably combined and fixed to the corresponding first combining portion 15 enables users to replace the press part 10 or the grip part 20 for assembly and disassembly according to different needs, and then effectively enhance the versatility and flexibility of the massage apparatus.

In this embodiment as shown in FIG. 16, the first combining portion 15 is either one of a screw hole 151 or a stud 281, the second combining portion 28 is the other one of the screw hole 151 or the stud 281, and the stud 281 is screwed and locked into the screw hole 151. In this specific embodiment, when the first combining portion 15 is the screw hole 151, the second combining portion 28 is the stud 281. When the first combining portion 15 is the stud 281, the second combining portion 28 is the screw hole 151. In this way, the external thread of the stud 281 and the internal thread of the screw hole 151 are engaged to combine and fix the second combining portion 28 with the first combining portion 15, so as to fix the press part 10 and the grip part 20 with each other.

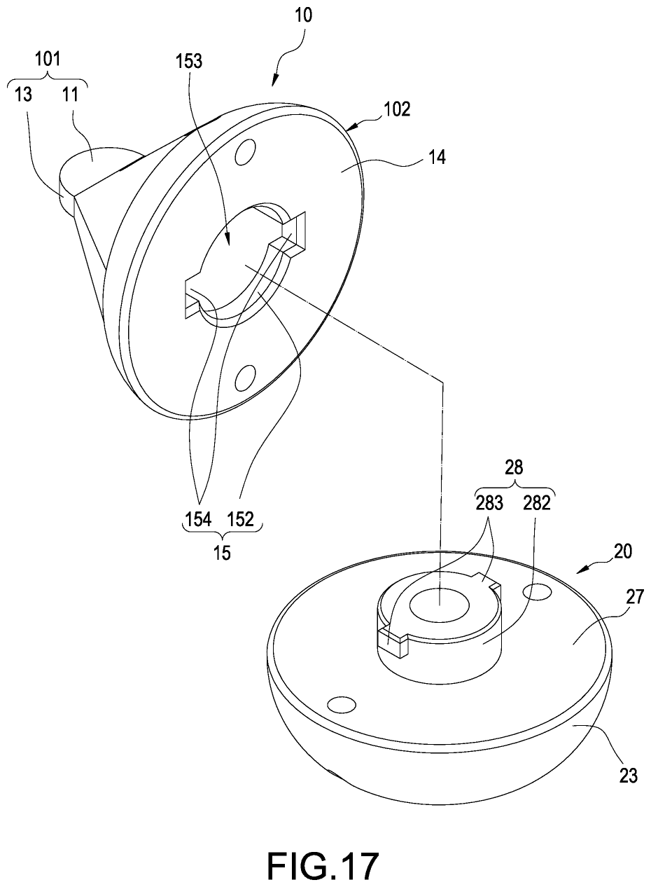

With reference to FIG. 17 for the sixth embodiment of the present disclosure, the main difference between this embodiment and the fifth embodiment is the structural combination of the first combining portion 15 and the second combining portion 28. In this specific embodiment, the first combining portion 15 is either one of a recessed hole 152 or a protruding column 282, the second combining portion 28 is the other one of the recessed hole 152 or thee protruding column 282, and the protruding column 282 is accommodated and engaged into the recessed hole 152. In this specific embodiment, when the first combining portion 15 is the recessed hole 152, the second combining portion 28 is the protruding column 282. When the first combining portion 15 is the protruding column 282, the second combining portion 28 is the recessed hole 152. The shape of the protruding column 282 corresponds to the shape of the recessed hole 152. In this embodiment, the recessed hole 152 is in a circular shape, and the protruding column 282 is in a cylindrical shape, but the present disclosure is not limited thereto. For example, the recessed hole 152 is in a triangular shape, a quadrilateral shape, a polygonal shape or an irregular shape in other embodiments.

It is noteworthy that the recessed hole 152 and the protruding column 282 of the sixth embodiment are tight-fit, so that the protruding column 282 is engaged in the recessed hole 152 and may fall off easily, but the present disclosure is not limited thereto. In some embodiments, when the press part 10 or grip part 20 with the recessed hole 152 is hollow and has a cavity 153, there is at least one block 283 extending from a sidewall of the protruding column 282, and at least one notch 154 formed on a side of the recessed hole 152, and the block 283 is aligned with and passes through the notch 154, and received in the cavity 153 together with the protruding column 282. After the protruding column 282 and the block 283 pass through the recessed hole 152 and the notch 154 respectively into the cavity 153, the press part 10 is rotated relative to the grip part 20 to turn and separate the block 283 away from the notch 154 to form a vertical stopping effect, so that the press part 10 and the grip part 20 are fixed and may not be separated easily.

It is noteworthy that although only the fifth and sixth embodiments are described with the drawings for illustration here, the combining method of the first combining portion 15 and the second combining portion 28 may have many other variations, for example, through the magnetic attraction between a magnetic member and a magnetically attracted member, or through the fixation between a snap hook and a snap hole, or through the adhesive fixation by hook and loop tapes, etc. The other combining methods not mentioned in this specification for the same purpose may be used, but these methods should be covered under the scope of the present disclosure.

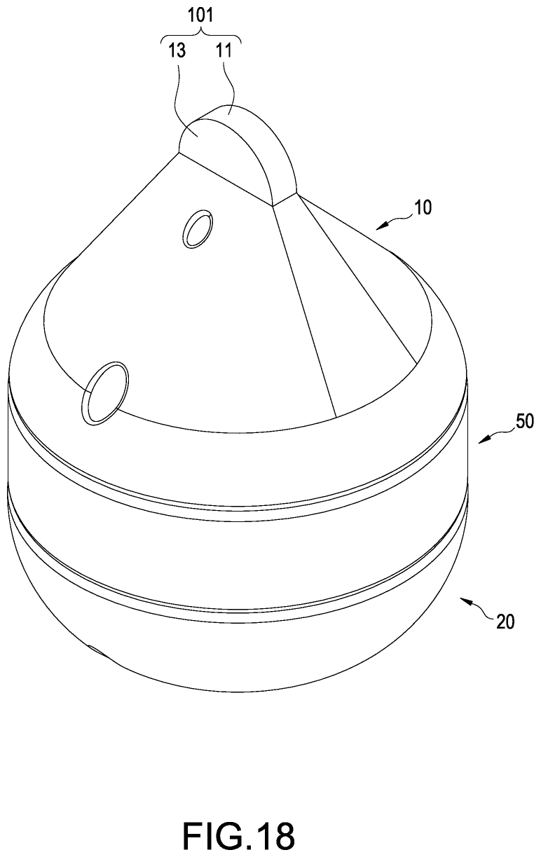

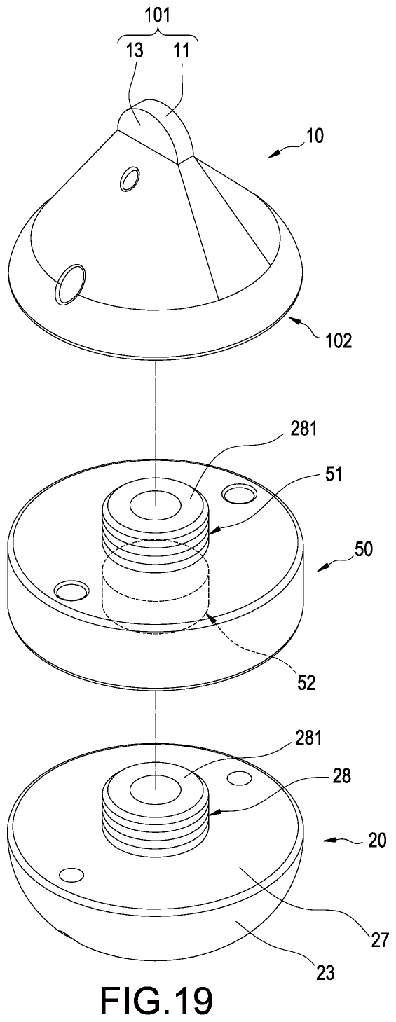

With reference to FIGS. 18 and 19 for the seventh embodiment of the present disclosure, the main difference between this embodiment and the fifth embodiment is that this embodiment further includes an extension part 50. The extension part 50 is in a disc shape or a cylindrical shape, and is detachably installed between the press part 10 and grip part 20. In this specific embodiment, the extension part 50 has a third combining portion 51 and a fourth combining portion 52 disposed on the upper and lower surfaces of the extension part 50 respectively. The structure of the third combining portion 51 is the same as the structure of the second combining portion 28 and is detachably combined and fixed with the corresponding first combining portion 15. The structure of the fourth combining portion 52 is the same as the structure of the first combining portion 15 and is detachably combined and fixed with the second combining portion 28. In this embodiment, the first combining portion 15 and the fourth combining portion 52 are screw holes 151, and the second combining portion 28 and the third combining portion 51 are studs 281, such that the extension part 50 may be detachably installed between the press part 10 and the grip part 20 to increase the length of the detachable massage apparatus and facilitate the use by different users.

In summation of the description above, there may be numerous other embodiments of the present disclosure, a person skilled in the art may make various corresponding changes and variations in accordance with the present disclosure without departing from the spirit of the present disclosure, but these corresponding changes and variations shall fall within the scope of protection of the patents applied for in the present disclosure.

What is claimed is:

1. A palm type massage apparatus, comprising:
a press part, comprising an abutting curved surface; and
a grip part, coupled to a side of the press part opposite to the abutting curved surface, and comprising a grip length,
wherein the grip length is equal to or smaller than 10 cm.

2. The palm type massage apparatus according to claim 1, wherein the grip length is greater than or equal to 6 cm and equal to or smaller than 8 cm.

3. The palm type massage apparatus according to claim 1, wherein a diameter of the abutting curved surface is greater than or equal to 2 mm and equal to or smaller than 10 mm.

4. The palm type massage apparatus according to claim 1, wherein a diameter of the abutting curved surface is greater than or equal to 4 mm and equal to or smaller than 8 mm.

5. The palm type massage apparatus according to claim 1, wherein the press part is in a hemispherical shape.

6. The palm type massage apparatus according to claim 1, wherein the press part is in a plate shape, and the press part comprises a pair of connecting bevels, and the connecting bevels extend outwardly and obliquely from two ends of the abutting curved surface to be coupled to the grip part.

7. The palm type massage apparatus according to claim 6, wherein a thickness of the press part is greater than or equal to 1 mm and equal to or smaller than 7 mm.

8. The palm type massage apparatus according to claim 7, wherein a thickness of the press part is greater than or equal to 3 mm and equal to or smaller than 5 mm.

9. The palm type massage apparatus according to claim 1, wherein the grip part comprises a first plane, a second plane and a grip curved surface, and the first plane and the second plane are coupled to two sides of the grip curved surface respectively.

10. The palm type massage apparatus according to claim 9, wherein a diameter of the grip curved surface is greater than or equal to 4 cm and equal to or smaller than 10 cm.

11. The palm type massage apparatus according to claim 10, wherein a diameter of the grip curved surface is greater than or equal to 6 cm and equal to or smaller than 8 cm.

12. The palm type massage apparatus according to claim 9, wherein an included angle is defined between the first plane and the second plane have, and the included angle is greater than or equal to 5° and equal to or smaller than 85°.

13. The palm type massage apparatus according to claim 12, wherein the included angle is greater than or equal to 10° and equal to or smaller than 45°.

14. The palm type massage apparatus according to claim 1, wherein the grip part comprises a conical section and a hemispherical section, the conical section expands gradually from the press part toward the hemispherical section, and the hemispherical section comprises a grip curved surface.

15. The palm type massage apparatus according to claim 14, wherein a diameter of the grip curved surface is greater than or equal to 4 cm and equal to or smaller than 10 cm.

16. The palm type massage apparatus according to claim 15, wherein a diameter of the grip curved surface is greater than or equal to 6 cm and equal to or smaller than 8 cm.

17. The palm type massage apparatus according to claim 1, further comprising a universal joint, disposed pivotally on a side of the grip part away from the press part.

18. The palm type massage apparatus according to claim 17, wherein the universal joint comprises a suction cup.

19. The palm type massage apparatus according to claim 1, wherein the grip part comprises a fixed hole.

20. The palm type massage apparatus according to claim 1, wherein the grip part comprises a pivot hole.

21. The palm type massage apparatus according to claim 1, wherein the press part comprises an abutting end and a connecting end opposite to each other, the connecting end comprises a first combining portion, the grip part comprises a second combining portion, and the second combining portion is detachably combined and fixed to the first combining portion.

22. The palm type massage apparatus according to claim 21, wherein the first combining portion is one of a screw hole and a stud, the second combining portion is another one of the screw hole and the stud, and the stud is screwed and locked in the screw hole.

23. The palm type massage apparatus according to claim 21, wherein the first combining portion is one of a recessed hole and a protruding column, the second combining portion is another one of the recessed hole and the protruding column, and the protruding column is accommodated and engaged in the recessed hole.

24. The palm type massage apparatus according to claim 23, wherein the protruding column comprises a block extending from a sidewall thereof, the recessed hole comprises a notched defined on a side thereof, and the block passes through the notch.

25. The palm type massage apparatus according to claim 21, wherein the press part expands gradually from the abutting end toward the connecting end.

26. The palm type massage apparatus according to claim 21, wherein the abutting end is in a semi-circular disc shape, the abutting end comprises a pair of side planes, and the abutting curved surface is coupled between the side planes.

27. The palm type massage apparatus according to claim 21, wherein the grip part is in a hemispherical shape, the grip part comprises an end surface and a grip curved surface, and the second combining portion is disposed on the end surface.

28. The palm type massage apparatus according to claim 21, further comprising an extension part detachably installed between the press part and the grip part.

29. The palm type massage apparatus according to claim 28, wherein the extension part comprises a third combining portion and a fourth combining portion disposed on two sides of the extension part opposite to each other, a structure of the third combining portion is same as a structure of the second combining portion, the third combining portion is detachably combined and fixed to the first combining portion, and a structure of the fourth combining portion is same as a structure of the first combining portion, and the fourth combining portion is detachably combined and fixed to the second combining portion.

30. The palm type massage apparatus according to claim 28, wherein the extension part is in a disc shape or a cylindrical shape.
